(19) United States
(12) Patent Application Publication
(10) Pub. No.: US 2003/0027558 A1
(43) Pub. Date: Feb. 6, 2003

(54) Method for executing a service for organisation of meetings for participants in a communications network, and service computer and program module for this

(75) Inventor: Bernd Eisinger, Stockern (AT)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/193,307

(22) Filed: Jul. 12, 2002

(30) Foreign Application Priority Data
Aug. 1, 2001 (EP) 01 440 247.3

(51) Int. Cl. H04M 3/42

(52) U.S. Cl. 455/414; 455/412; 455/456

(57) ABSTRACT

The invention relates to a method for executing a service for organization of meetings for participants in a communications network with the steps: Storage of an invitation to a meeting transmitted from a terminal device of an inviting participant, specifying the location, time and a participant identifier, in particular a call number or a network address, of one or more invited participants, Receiving of location information about an invited participant (SA), Determination of a travel route from the location of the invited participant (SA) to the meeting place, and estimation of the travel time required by this participant (SA), Calculation of a time, allowing for the estimated travel time, at which the invited participant (SA) must begin his journey and Sending of information, in particular a message containing travel details and a recommended starting time for the journey, to a terminal device of the invited participant (SA) at least once by this time, along with a service computer (MS) and program module for this.

### BACKGROUND OF THE INVENTION

The invention is based on a priority application EP 01 440 247.3 which is hereby incorporated by reference.

The invention relates to a method for executing a service for organization of meetings for participants in a communications network, as well as a service computer and a program module to run in a service computer for this.

Meetings are often planned with a lead time. A person issuing invitations and planning a meeting will inform and invite the desired participants for the meeting in good time. For communication with these participants he normally uses popular communications facilities, such as telephone, fax or, if he and the participants are connected to the Internet or an intranet, electronic mail (email). A disadvantage of this method is its lack of flexibility. Thus for preparing a planned meeting there must often be time-consuming consultation on dates among the participants. It is especially awkward when a planned meeting has to be postponed at short notice.

On the Internet, so-called online calendars are available, which allow the participants in a usually closed user group to arrange appointments among themselves by means of an (electronic) appointment calendar, which these participants can jointly view and in which they can also optionally enter appointments. The participants all have access to a corresponding Internet page, which is stored on a so-called (Internet) server and in each case can be loaded by means of an Internet terminal device, generally using a personal computer with a browser, into the respective Internet terminal device. Entries or changes can then be made at the terminal device and sent back to the server. When the server accepts these entries, they can immediately be made available, i.e. retrievable, for the other participants. This enables flexible consultation and scheduling of appointments among the participants.

One disadvantage of the method referred to is that the inviting person, hereinafter more generally called the inviting participant, must always expect that individual participants, especially with a long lead time, will forget the planned meeting, have to take on unexpected appointments or be faced with unexpected obstacles such as delays on their selected means of transport, or that delays arise from incorrectly planned travel times.

### SUMMARY OF THE INVENTION

The object of the invention is the creation of a method and the necessary means for implementing it, for executing a service for organization of meetings for participants, which service enables the inviting participant to organize meetings in a convenient way and to support the invited participants in planning and executing the respective necessary journeys.

The basic idea of the invention is that an inviting participant first transmits, to a service computer of the communications network, an invitation to a meeting, specifying the place, time and a participant identifier, in particular a call number or a network address, of one or more invited participants. For each of the invited participants a travel route for reaching the meeting place is determined. The travel time probably required is also estimated in each case. Based on these travel times, a respective time is then determined, for instance a certain time before the recommended start of the journey. At least once by the time determined for this participant, each participant receives information including in particular the relevant travel information and a recommended time for starting the journey.

Further advantageous developments of the invention can be taken from the dependent claims and the description.

### BRIEF DESCRIPTION OF THE DRAWING

The invention is further explained hereinafter with the help of the drawing:

FIG. 1 shows a diagram of a communications network for implementing the method according to the invention.

FIG. 1 shows a communications network CN as an example with a switching center EX and a service computer MS. With the switching center EX, a participant terminal device of an invited participant SA and a participant terminal device of an inviting participant SB are linked as an example. The service computer MS is linked to the switching center EX and an (external) database DB.

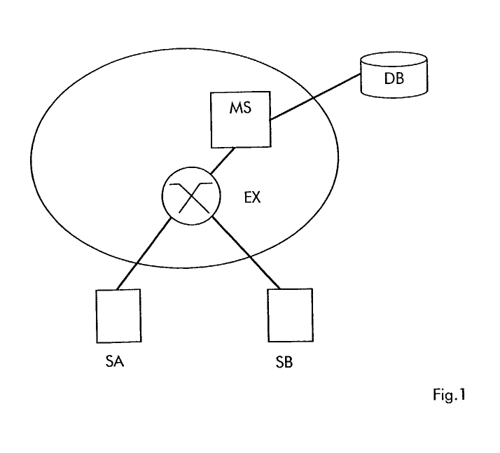

To simplify the language, both a participating person and the participant terminal device used by this person are hereinafter simply referred to as a participant.

The communications network CN preferably represents a mobile telephony network, for example a mobile telephony network of the widespread GSM standard (Engl.: Global System for Mobile Communication). For simplification it is to be assumed here that both participants SA and SB are connected to the same switching center EX. The network CN can also be implemented as a hybrid network of different or physically differently implemented networks, in which the participants SA and SB represent different terminal devices, for instance a mobile radio device and an Internet terminal device.

The service computer MS is initially seen as a compact computer assigned to a switching center EX. The service computer here presents functions for service control, for administration and storage of relevant data for the method according to the invention, and for participant communication. The service computer MS can alternatively be a multi-computer system or consist of several computers communicating with each other. In particular, as explained in detail later, the various described tasks, such as the service control, the data administration and the participant communication, can also be allocated to physically different computers, e.g. the service control and the data administration to a central computer, and the participant communication to decentralized computers each assigned to a switching center EX of the communications network CN.

A simple functional communications sequence for the organization of a meeting by an inviting participant SB and for support of the planning of an invited participant SA within the scope of the method according to the invention is to be described hereinafter. This sequence can be represented in two parts:

a) Organization of a meeting:

An inviting participant SB requests a connection to a service computer MS by entering a certain service call number, and transmits an invitation to a meeting, specifying location, time of the meeting and the call numbers of invited participants,

The service computer MS requests a connection to the invited participants by passing the call numbers to the switching center EX, and transmits the invitation to each of these participants,

the invited participants, in accepting the invitation, each send a confirmation of their location before the start of the journey (i.e. usually place of residence or of work), the planned means of transport (e.g. car, plane+taxi, plane (Air France)+suburban railway, etc.) and optional further details (e.g. that a stay of a certain length in a certain location should be envisaged) to the service computer MS,

the service computer MS requests a connection to the inviting participant SB and transmits a message about the received confirmations and

the inviting participant SB transmits a confirmation that the planned meeting will take place.

b) Support for the planning of the invited participants, with the example of participant SA:

The service computer MS sets up a connection to an external database DB, which is selected according to the chosen means of transport, and transmits the location of invited participant SA, the meeting place, the start of the meeting and any other applicable details to this database,

the database DB determines one or more possible travel routes or travel options with an associated timetable, and transmits this information to the service computer MS,

the service computer MS chooses a travel option, for instance the option with the shortest travel time,

based on the established duration of the chosen travel connection, the service computer MS calculates a time by which the invited participant SA must begin his journey, it being possible to include a security margin, for instance 10 minutes, in the calculation of this time, and

at least once by the calculated time, the service computer MS sends the invited participant SA a message, which contains travel details such as the established travel route, timetable or traffic information and a recommended time for starting the journey.

In an alternative embodiment, a table relating (participant) names (or unique participant identifiers, such as unique numbers) to the corresponding call numbers is stored in the service computer. In an invitation, the names of the invited participants can then also be sent to the service computer WS instead of their call numbers. The service computer then finds these participants' call numbers by using the aforementioned table.

It is also possible to have a profile stored for all or certain participants, holding for example their place of residence or of work, preferred means of transport and other travel habits. It is furthermore possible to store the participants' preferred times and form for receiving the above travel information from the service computer MS. The cost of communication between the participants and the service computer MS can thus be restricted to a minimum.

It is further possible that the service computer MS automatically makes a travel reservation for an invited participant SA, and informs him about this.

Participants in a cellular mobile telephony network, such as the GSM network, have their location continuously fixed. As soon as a participant leaves a so-called geographic area of the network and enters a new geographic area, this participant and the new geographic area are marked in a so-called visitor file (Visitors Location Register, VLR). In addition, methods are known by which locating can be much more precise than location to a geographic area, e.g. with the help of field strength measurements of the radio signals received from the mobile terminal. Alternatively, precise locating of participants can also be achieved by means of the Global Positioning System (GPS). The administration of the locating data and if applicable the control of the locating function is preferably executed by a locating service computer (location server) in the mobile telephony network CN.

The automatic locating of participants is used here in an advantageous extension of the invention to adapt the travel route or travel option to the current location of the invited participant, i.e. the location of his mobile radio device. For this, the service computer MS requests up-to-date location information cyclically, e.g. at intervals of 5 minutes, for an invited participant SA from the specified location server, and determines a new travel route with the help of the specified database DB, in the case of a significant location change.

This automatic participant locating can be executed especially advantageously to send current navigation information to the participant SA from the start of the journey. Furthermore, this participant can be informed, continuously or on request, whether he will probably arrive on time, or if he is delayed, for example because of a delayed transport, he can be notified of a calculated probable late arrival time. This information can also be passed to the inviting participant SB, who can thus learn at the earliest possible moment, which invited participants SA will probably arrive late, and what delay times are involved.

It is also possible in principle to allow all participants SA and SB in a meeting to make contact with service computer MS, to find out about the status of the meeting (e.g. about participants, corresponding call numbers or delay status). In a further embodiment, participants for whom an attendance confirmation for a meeting is stored in the service computer MS can be deleted again from the list of participants. This deletion can take place explicitly on the service computer as a result of a request by the relevant participant SA, or the inviting participant SB. The deletion can also occur after it is established that the invited participant will reach the meeting place so late, for example arriving more than an hour late, that it is no longer sensible to include participant SA. The service computer informs the inviting participant or invited participant SB about the deletion.

Until now it has been implicitly assumed that the communication between participants SA and SB and the service computer MS is by speech. For this, on receipt of information in the service computer MS, a conversion from speech into digital information occurs (speech-to-text conversion), and for output of information a conversion from digital information into speech (text-to-speech conversion). Alternatively, the exchange of information can also be made with so-called short messages in a short message system (SMS).

The service computer MS can be a so-called Internet server or WWW (World Wide Web) server, which allows an inviting participant SB to organize a meeting with an Internet terminal device by means of an online calendar as described at the start. As a result of the possibility of comfortable information input with so-called forms, i.e. Internet pages or web sites, which present fields for input of information and a visual display of extensive information, a meeting can thereby be planned very conveniently and transparently for all participants. With the introduction of the mobile Internet in the Universal Mobile Telephone Systems (UMTS), extensive travel and navigation information can then be presented graphically for the invited participant SA while travelling, provided he has a corresponding terminal device.

The invited participant SA can also represent a mobile radio device with a WAP browser, which communicates by means of WAP pages with a corresponding service computer developed as a WAP server. The communication by WAP pages is largely identical from the user's angle with the previously described communication on the Internet using web pages; however, WAP pages offer no possibility for graphic representation of information.

It is possible that the service computer MS consists of a central computer for service administration and control, and several decentralized communication computers, which are arranged decentrally in the communications network, for instance assigned to the switching centers EX. To be able to communicate with various types of participant terminal devices, various correspondingly developed communications computers can also be provided. Thus a communications computer can be developed as a WAP server, which communicates with the participants SA and SB independently using WAP pages. Between the WAP server and the service computer MS is then essentially only useful data, i.e. data relevant for the service. Information that serves only for participant menu prompting can be generated locally by the WAP server. Correspondingly, an interface computer can be developed as an Internet server. The service computer MS is then essentially only responsible for the control of the service and storage of relevant data.

In an execution of the described service in the so-called Intelligent Network of the mobile telephony network or a conventional telephone network, the switching center EX is developed as a so-called service switching point SSP, to which a local communications computer is connected for speech communication. A central service control computer is developed as a so-called central service control point SCP. The inviting participant SB then dials e.g. a certain service number, which is identified in the service switching point. The service switching point informs the service control point, which instructs the responsible communications computer to communicate with the participant SB by speech communication and establish relevant data for the planned meeting. This data is then stored in the service control computer, for example, or in a separate service administration computer. The above travel information is calculated in the service administration computer, which communicates with the external database DB for this purpose. On the basis of the established data, the service control computer controls the necessary actions, such as informing the participants at times calculated or specified in each case, by instructions to the corresponding service switching points and the corresponding communication computers.

1. Method for executing a service for organization of meetings for participants in a communications network, wherein the following steps are executed:
Storage of an invitation to a meeting transmitted from a terminal device of an inviting participant, specifying the location, time and a participant identifier, in particular a call number or a network address, of one or more invited participants,
Receiving of information about the location (of residence) of an invited participant,
Determination of a travel route from the location of the invited participant to the meeting place, and estimation of the travel time required by this participant,
Calculation of a time, allowing for the estimated travel time, at which the invited participant must begin his journey and
Sending of information to a terminal device of the invited participant at least once by this time, in particular a message containing travel details and a recommended starting time for the journey.

2. Method as claimed in claim 1, wherein selected means of transport are considered for determining the travel route, and current timetables and/or traffic situations that are relevant for these means of transport are consulted to estimate the travel time.

3. Method as claimed in claim 1, wherein an automatic locating of the terminal device of the invited participant occurs, and the travel time estimate is made continuously or repeatedly based on the current location thereby established.

4. Method as claimed in claim 3, wherein from the time suggested for beginning the journey, depending on the established location, current navigation information or travel information is determined continuously or repeatedly and sent to this participant's terminal device.

5. Method as claimed in claim 3, wherein from the time suggested for beginning the journey, it is continuously or repeatedly determined whether the established location permits the expectation that the invited participant will reach the meeting place on time, and this information is transmitted to the terminal device of the invited participant or the terminal device of the inviting participant.

6. Method as claimed in claim 5, wherein if applicable, a probable delay time is calculated and this delay time is transmitted to the terminal device of the invited participant or to the terminal device of the inviting participant.

7. Service computer for organization of meetings for participants in a communications network, with means of executing the following steps:
Storage of an invitation to a meeting transmitted from a terminal device of an inviting participant, specifying the location, time and a participant identifier, in particular a call number or a network address, of one or more invited participants,
Receiving of information about the location (of residence) of an invited participant,
Determination of a travel route from the location of the invited participant to the meeting place, and estimation of the travel time required by this participant,
Calculation of a time, allowing for the estimated travel time, at which the invited participant must begin his journey and
Sending of information to a terminal device of the invited participant at least once by this time, in particular a message containing travel details and a recommended starting time for the journey.

8. Program module for running in a service computer for organization of meetings for participants in a communications network with means of controlling the following steps:
Storage of an invitation to a meeting transmitted from a terminal device of an inviting participant, specifying the location, time and a participant identifier, in particular a call number or a network address, of one or more invited participants,
Receiving of information about the location (of residence) of an invited participant,
Determination of a travel route from the location of the invited participant to the meeting place, and estimation of the travel time required by this participant,
Calculation of a time, allowing for the estimated travel time, at which the invited participant must begin his journey and
Sending of information to a terminal device of the invited participant at least once by this time, in particular a message containing travel details and a recommended starting time for the journey.
